(19) United States
(12) Patent Application Publication
(10) Pub. No.: US 2018/0238631 A1
(43) Pub. Date: Aug. 23, 2018

(54) PLATE-TYPE VACUUM HEAT TRANSFER APPARATUS FOR TELEVISION

(71) Applicants: IBT Co., Ltd., Gwangju (KR); SAMSUNG ELECTRONICS CO., LTD., Gyeonggo-do (KR)

(72) Inventors: Sang Koo Park, Siheung-si (KR); Jin Hyun Cho, Seoul (KR)

(21) Appl. No.: 15/437,243

(22) Filed: Feb. 20, 2017

(51) Int. Cl. F28D 15/02; F28D 15/04; H04N 5/64

(52) U.S. Cl. CPC F28D 15/0233; H04N 5/64; F28D 15/046

(57) ABSTRACT

Disclosed herein is a plate-type vacuum heat transfer apparatus for a television. The apparatus includes a first plate and a second plate sealed to define an internal space in a vacuum state, a mesh member disposed between the first and second plates, and a heat transfer medium supplied to a portion of the internal space. Each of the first and second plates includes an edge protruding to a hexagonal honeycomb structure formed such that a vertex thereof is located in a direction of gravity. Hexagonal honeycomb structures of the first and second plates overlap at some edges to be offset from each other, thus providing the internal space for allowing communication and a flow passage of the heat transfer medium.

### BACKGROUND OF THE INVENTION

### 1. Field of the Invention

The present invention relates to a plate-type vacuum heat transfer apparatus for a television. More particularly, the present invention relates to a plate-type vacuum heat transfer apparatus for a television, which has a vacuum therein and is attached to a display device for the television, thus preventing a product from malfunctioning or being damaged or broken due to heat generation.

### 2. Description of the Related Art

A conventional heat pipe is divided into an evaporation part (heat absorbing part) that obtains heat and a condensation part (heat emitting part) that emits heat, and has a vacuum therein, so that it transfers heat at a rate that is about 1,000 times higher than copper, which has high heat conductivity. Thus, the heat pipe is attached to a CPU, a graphic card or the like of a computer that generates high temperature heat.

However, such a heat pipe is problematic in that the areas of the heat absorbing part and the condensation part are small because of the mechanical properties thereof, so that it is difficult to deal with a product having a large heat generating area or a product generating high temperature heat. Consequently, an additional device such as a heat sink or a fan is required. Further, the heat pipe is operated in a natural circulating system using gravity. Here, if a heating element has the same height as the condensation part or the heating element is installed relative to the condensation part at the angle of 15° or less, performance may be considerably deteriorated and thereby the heat pipe may frequently malfunction.

As illustrated in FIGS. 1 to 3, a conventional heat pipe 100 is made of metal such as copper or aluminum having high heat conductivity and is composed of a container 110 having the shape of a cylindrical rod. A sintered, meshed or grooved wick 120 is provided on an inner wall of the heat pipe 100, a heat transfer medium is injected into an empty space thereof, and a vacuum is created in the heat pipe.

The conventional heat pipe 100 has the structure of the cylindrical rod to ensure fast evaporation and condensation and thereby increase a heat transfer rate. However, although the structure of the cylindrical rod ensures fast evaporation and condensation, it has a small contact surface, so that its application is limited to a small-sized product, such as a CPU or a graphic card of a computer, and the positions of the evaporation part and the condensation part are fixed, so that the designing of a device is limited. Further, since the heat pipe is made of copper or aluminum so as to increase heat conductivity, rigidity is relatively low and it is difficult to handle and manufacture.

Korean Patent No. 10-0775013 has proposed a “Plate-type heat transfer apparatus”, which is shown in FIG. 4. The plate-type heat transfer apparatus 200 includes: first and second plates 210 and 220 that define a sealed internal space; a refrigerant that is injected into an internal space; a capillary wick 230 that is in close contact with at least one of the first and second plates 210 and 220 in the internal space to absorb liquid-phase refrigerant; and a hole structure 240 having bent parts 241 and holes 242. The bent parts 241 are formed by cutting and bending predetermined portions of the hole structure to define a space, thus allowing gas-phase refrigerant to smoothly pass between the first and second plates 210 and 220, and support the capillary wick 230. The holes 242 are formed in portions that are cut to form the bent parts 241, so that gas-phase refrigerant vaporized in the capillary wick 230 passes therethrough.

Therefore, an advantage of the related art is that the entire structure is simple, and the refrigerant flows smoothly, thus providing good cooling efficiency. However, the related art is problematic in that the interior does not maintain a vacuum state, so that it is impossible to manufacture and apply the heat pipe in a large area. Further, the hole structure 240 is configured to have the bent parts 241 and the holes 242 considering only the smooth passing of the gas-phase refrigerant, so that a horizontal configuration is possible but a vertical configuration is impossible.

The foregoing is intended merely to aid in the understanding of the background of the present invention, and is not intended to mean that the present invention falls within the purview of the related art that is already known to those skilled in the art.

### RELATED ART DOCUMENT

### Patent Document

(Patent 1) Korean Patent No. 10-0775013

### SUMMARY OF THE INVENTION

Accordingly, the present invention has been made keeping in mind the above problems occurring in the related art, and an object of the present invention is to provide a plate-type vacuum heat transfer apparatus for a television, in which an interior of a plate-type container made of a plate having hexagonal honeycomb structures is configured in a vacuum state, and vapor diffusion and condensation recycling of a heat transfer medium are implemented via the hexagonal honeycomb structures communicating with each other, thus realizing a large area with a simple configuration and allowing the apparatus to be used in a vertical configuration.

In order to accomplish the above object, the present invention provides a plate-type vacuum heat transfer apparatus for a television including a first plate and a second plate sealed to define an internal space in a vacuum state; a mesh member disposed between the first and second plates; and a heat transfer medium supplied to a portion of the internal space, wherein each of the first and second plates may include an edge protruding to a hexagonal honeycomb structure formed such that a vertex thereof may be located in a direction of gravity, and hexagonal honeycomb structures of the first and second plates may overlap at some edges to be offset from each other, thus providing the internal space for allowing communication and a flow passage of the heat transfer medium.

The edge may be discontinuous to communicate with a hexagonal honeycomb structure formed therein.

Each of the hexagonal honeycomb structures may further include a dent preventing protrusion provided on a center thereof to protrude in the same direction and height as the edge and thereby come into close contact with a facing edge.

The plate-type vacuum heat transfer apparatus for the television may have a size corresponding to a display area of 55 inches.

Each of the first and second plates may be made of an STS 304 material of 0.3 mm.

The plate-type vacuum heat transfer apparatus for the television may have a thickness of 1.2 mm.

As described above, the present invention provides a plate-type vacuum heat transfer apparatus for a television, in which an interior of a plate-type container made of a plate having hexagonal honeycomb structures is configured in a vacuum state, and vapor diffusion and condensation recycling of a heat transfer medium are implemented via the hexagonal honeycomb structures communicating with each other, thus realizing a large area with a simple configuration and allowing the apparatus to be used in a vertical configuration.

### BRIEF DESCRIPTION OF THE DRAWINGS

The above and other objects, features and advantages of the present invention will be more clearly understood from the following detailed description taken in conjunction with the accompanying drawings, in which:

FIGS. 1 to 3 are a plan view and sectional views illustrating the configuration of a conventional heat pipe;

FIG. 4 is an exploded perspective view illustrating the configuration of a conventional plate-type heat transfer apparatus;

FIG. 5 is a partially cutaway perspective view illustrating the configuration of a plate-type vacuum heat transfer apparatus for a television according to an embodiment of the present invention;

FIGS. 6 and 7 are plan views illustrating first and second plates of FIG. 5; and

FIGS. 8 and 9 are plan views illustrating different shapes of first and second plates of FIG. 5.

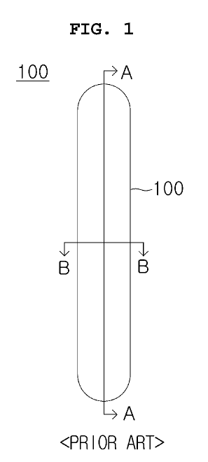

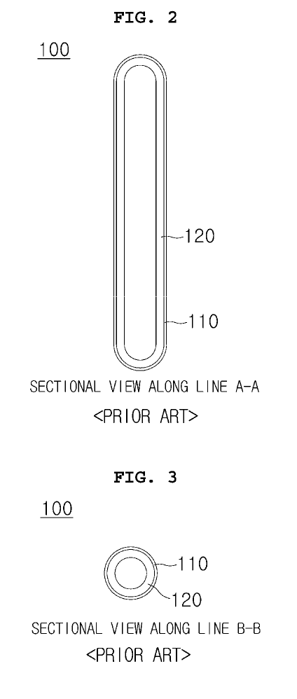

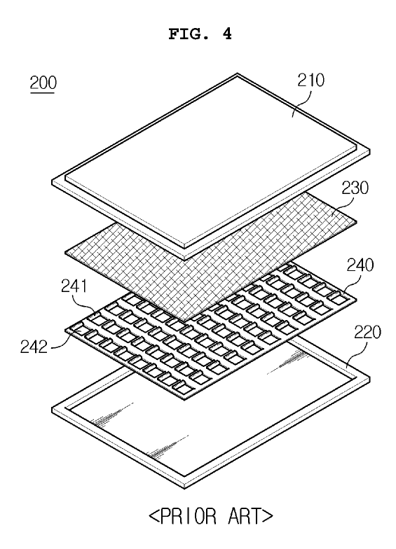

### DESCRIPTION OF PREFERRED EMBODIMENTS

Hereinafter, a preferred embodiment of a plate-type vacuum heat transfer apparatus for a television according to the present invention will be described in detail with reference to the accompanying drawings.

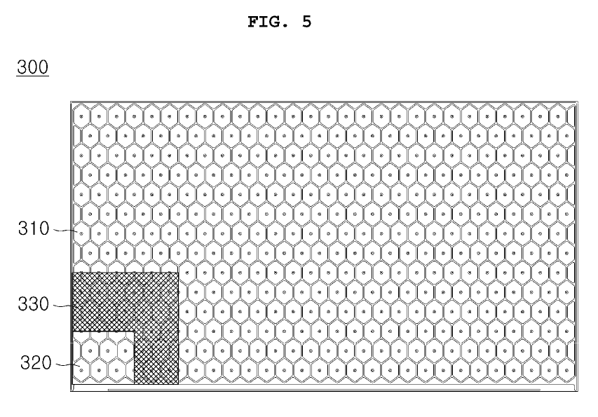

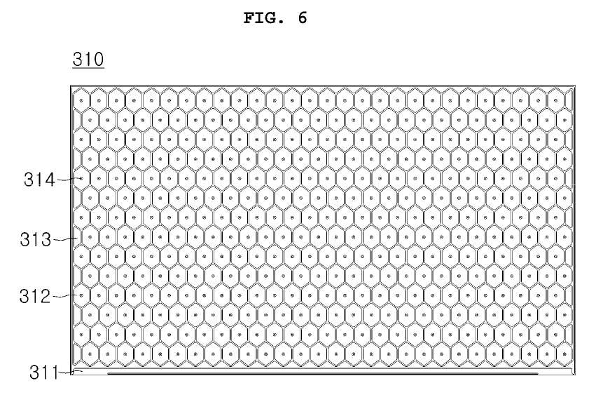

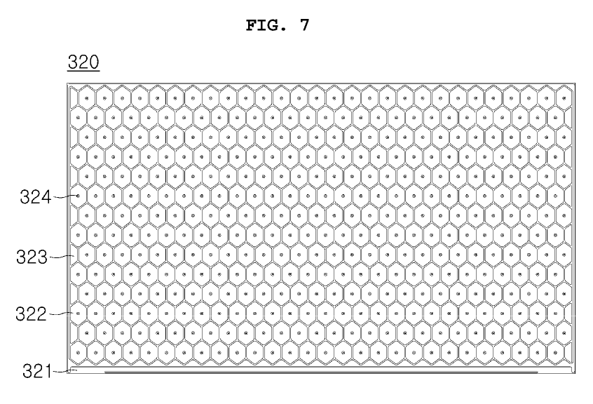

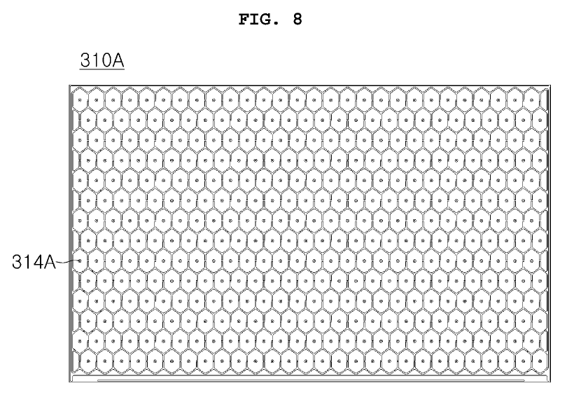

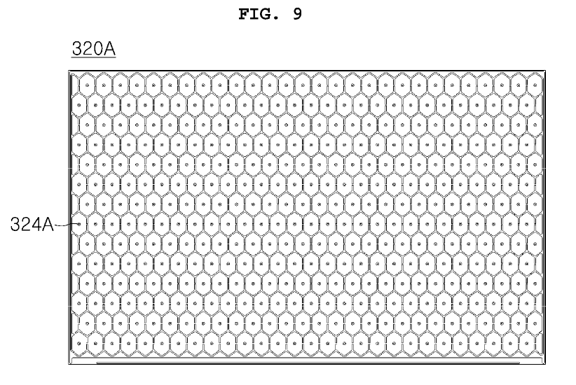

FIG. 5 is a perspective view illustrating the configuration of a plate-type vacuum heat transfer apparatus for a television according to an embodiment of the present invention, FIGS. 6 and 7 are plan views illustrating first and second plates of FIG. 5, and FIGS. 8 and 9 are plan views illustrating different shapes of first and second plates of FIG. 5.

As illustrated in FIG. 5, the plate-type vacuum heat transfer apparatus 300 for the television according to this embodiment has a plate-type container with an internal space. In this regard, the plate-type container is formed into one plate-type structure by overlapping two plates, namely, first and second plates 310 and 320 that are thin but are large in area and then welding outer edges thereof. As the welding method, argon welding, laser welding or plasma welding may be used. Meanwhile, a mesh member 330 is inserted into the internal space of the plate-type container, and a small amount of heat transfer medium is injected into an internal space in a vacuum state.

As illustrated in FIGS. 5 to 7, the first and second plates 310 and 320 come into contact with a heating element of an LED module and ambient air to transfer heat absorbed from the heating element and to emit the heat to the ambient air. The first and second plates are made of a plate-type stainless material. As the first and second plates 310 and 320 are made in the plate form, a contact area with the heating element is large and a contact area with the ambient air is also large, so that more efficient heat emission is possible. Preferably, the first and second plates 310 and 320 are made of an STS 304 material that possesses high strength and good corrosion resistance and heat emitting performance and has a thickness of 0.3 mm or less. As the first and second plates 310 and 320 are made of the stainless steel material, it is possible to improve rigidity.

As such, the internal space is defined in the plate-type container by the first and second plates 310 and 320. Such an internal space is formed by making the edges of the first and second plates 310 and 320 in a stepped form. That is, the first and second plates 310 and 320 are formed such that the edges thereof are stepped upwards or downwards, thus forming a surface contact portion, and are corner-welded to each other at ends of the portion. Meanwhile, the first and second plates 310 and 320 are configured such that a surface contact area is large at first edges thereof and LED module-mounting parts 311 and 321 are provided on the area to allow the LED module to be mounted thereon. The LED module-mounting parts 311 and 321 are located at the lowermost position of the television when the apparatus is applied to the television.

Meanwhile, when the vacuum is applied to the internal space defined by the first and second plates 310 and 320, the first and second plates 310 and 320 are compressed against each other, so that the internal space is eliminated or deformed. Therefore, a bead of a predetermined shape is provided, which is supported by partially overlapping the first and second plates 310 and 320 of this embodiment when the vacuum is applied to the internal space. In other words, when the bead is formed on the first and second plates 310 and 320, configuration is implemented to have the bead of the hexagonal honeycomb structure, namely, an edge protruding to the hexagonal honeycomb structure that enables the vapor diffusion and the condensation recycling of the heat transfer medium in an entire area of the internal space. The bead of such a hexagonal honeycomb structure provides diagonal and vertical flow passages.

Therefore, each of the first and second plates 310 and 320 of this embodiment forms the bead of the hexagonal honeycomb structure. The bead is formed such that its vertex is located in the direction of gravity. Further, the hexagonal honeycomb structures of the first and second plates 310 and 320 overlap at some edges thereof to be offset from each other, thus providing an internal space for allowing communication and a flow passage of the heat transfer medium.

To this end, as illustrated in FIGS. 6 and 7, the plate having the bead of the hexagonal honeycomb structure is manufactured by pressing a plate of a stainless material such that complete shapes of hexagonal beads 312 and 322 and half shapes of hexagonal beads 313 or 323 are formed at the outermost location of the same layer. In the plate manufactured as such, the plate placed in a press-forming direction is used as the first plate 310, while the plate overturned in a direction opposite to the press-forming direction is used as the second plate 320. If the first and second plates 310 and 320 are arranged to overlap each other, the hexagonal honeycomb structures of the first and second plates 310 and 320 overlap at some edges thereof to be offset from each other, thus providing an internal space for allowing communication and a flow passage of the heat transfer medium.

Preferably, the first and second plates 310 and 320 further include dent preventing protrusions 314 and 324 that are provided on centers in the hexagonal honeycomb structures to protrude in the same direction and height as the edge and thereby come into close contact with facing edges of the second and first plates 320 and 310. The dent preventing protrusions 314 and 324 prevent the first and second plates 310 and 320 from being dented towards the internal space as the vacuum is applied to the internal space, in addition to serving as guides that allow the heat transfer medium to smoothly flow.

As illustrated in FIGS. 8 and 9, first and second plates 310A and 320A may be configured such that edges of hexagonal honeycomb structures thereof have a discontinuous shape to communicate with other hexagonal honeycomb structures formed therein. As the discontinuous shape allows adjacent hexagonal honeycomb structures to directly communicate with each other, more efficient vapor diffusion and condensation recycling of the heat transfer medium are possible.

Further, the first and second plates 310A and 320A may further include dent preventing protrusions 314A and 324A that are provided on centers in the hexagonal honeycomb structures to protrude in the same direction and height as the edge and thereby come into close contact with facing edges of the second and first plates 320A and 310A.

The mesh member 330 is interposed between the first and second plates 310 and 320 to provide a passage through which the heat transfer medium may smoothly flow. That is, the mesh member 330 enables the vapor diffusion and the condensation recycling of the heat transfer medium in an entire area of the internal space, in cooperation with the beads of the hexagonal honeycomb structures of the first and second plates 310 and 320. Therefore, the mesh member 330 is a mesh-net structure and is preferably made of an STS 304 material having high strength and good corrosion resistance.

The heat transfer medium is inserted into a portion of the internal space of the plate-type container, absorbs heat generated from an evaporation part to be evaporated, exchanges heat with an entire area (condensation part) coming into contact with the ambient air to emit the heat, is condensed from a vapor phase to a liquid phase, and then is moved to the evaporation part. Thus, the heat transfer medium preferably uses pure water satisfying the above-described conditions.

In the case of injecting the heat transfer medium into an air layer of the internal space, a perforation is formed in a side of the first plate 310, and the heat transfer medium is injected through the perforation. If the heat transfer medium is injected as such, the heat transfer medium is cooled, a vacuum is applied through the perforation, and then the perforation is sealed. Air cooling is performed at room temperature. As a result, an interior has a constant vacuum level.

The heat transfer mechanism of the plate-type vacuum heat transfer apparatus 300 for the television according to this embodiment configured as such is implemented such that a part to which the heating element of the LED module is attached serves as the evaporation part and a remaining part serves as a condensation part. That is, if heat is introduced from the evaporation part, the interior has a vacuum state, so that the heat transfer medium is evaporated at 40° C. or less to be changed into the vapor phase, is moved upwards along the flow passage defined by the hexagonal honeycomb structures and the mesh member 330, and exchanges heat with the entire area (condensation part) that is in contact with the ambient air, so that it emits heat and is condensed from the vapor phase to the liquid phase again. The condensed heat transfer medium moves along the hexagonal honeycomb structures and the mesh member 330 to a position at which the evaporation part is located, and then heat is emitted to an outside by repeating the above-described process.

The plate-type vacuum heat transfer apparatus 300 for the television according to this embodiment is configured such that a vacuum is created in the state where the heat transfer medium is inserted into a portion of the internal space of the plate-type container. That is, as the internal space has the vacuum state, the heat transfer medium is repeatedly evaporated and condensed at low temperature, thus allowing the heat generated from the heating element to be more efficiently emitted. Further, the vapor diffusion and the condensation recycling of the heat transfer medium are performed through the hexagonal honeycomb structures communicating with each other, so that it is possible to realize a large area with a simple configuration and to use a vertical configuration.

Meanwhile, the plate-type vacuum heat transfer apparatus 300 for the television according to this embodiment may be composed of the first and second plates 310 and 320 to have an entire thickness of 1.2 mm using an STS 304 material of 0.3 mm having a size corresponding to a display area of 55 inches.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A plate-type vacuum heat transfer apparatus for a television comprising:
a first plate and a second plate sealed to define an internal space in a vacuum state;
a mesh member disposed between the first and second plates; and
a heat transfer medium supplied to a portion of the internal space,
wherein each of the first and second plates comprises an edge protruding to a hexagonal honeycomb structure formed such that a vertex thereof is located in a direction of gravity, and
hexagonal honeycomb structures of the first and second plates overlap at some edges to be offset from each other, thus providing the internal space for allowing communication and a flow passage of the heat transfer medium.

2. The plate-type vacuum heat transfer apparatus as set forth in claim 1, wherein the edge is discontinuous to communicate with a hexagonal honeycomb structure formed therein.

3. The plate-type vacuum heat transfer apparatus as set forth in claim 1, wherein each of the hexagonal honeycomb structures further comprises:
a dent preventing protrusion provided on a center thereof to protrude in the same direction and height as the edge and thereby come into close contact with a facing edge.

4. The plate-type vacuum heat transfer apparatus as set forth in claim 1, wherein the plate-type vacuum heat transfer apparatus for the television has a size corresponding to a display area of 55 inches.

5. The plate-type vacuum heat transfer apparatus as set forth in claim 1, wherein each of the first and second plates is made of an STS 304 material of 0.3 mm.

6. The plate-type vacuum heat transfer apparatus as set forth in claim 1, wherein the plate-type vacuum heat transfer apparatus for the television has a thickness of 1.2 mm.
